(19) United States
(12) Patent Application Publication
(10) Pub. No.: US 2011/0231135 A1
(43) Pub. Date: Sep. 22, 2011

(54) Auto-correcting or self-calibrating DTS temperature sensing systems and methods

(76) Inventors: Kwang Suh, Lakeway, TX (US); Kent Kalar, Sunset Valley, TX (US); Chung Lee, Austin, TX (US); Michael Sanders, Austin, TX (US)

(21) Appl. No.: 12/998,200

(22) PCT Filed: Sep. 25, 2009
(86) PCT No.: PCT/US2009/005327

§ 371 Date: Mar. 26, 2011

Related U.S. Application Data
(60) Provisional application No. 61/194,451, filed on Sep. 27, 2008.

(51) Int. Cl. G01K 15/00; G06F 19/00

(52) U.S. Cl. 702/99; 374/1; 374/E15.001

(57) ABSTRACT

An automatic auto-correcting method is presented to improve the accuracy of fiber optic distributed temperature measurements derived from Raman back scatterings utilizing two light sources with different wavelengths, by appropriate choice of the wavelengths of the two sources, the use of single pulse modulating circuit for the two light sources, and use of one of the light sources as a primary measurement system and the second light source as an occasional correcting source.

### FIELD AND BACKGROUND

1. Field of the Invention

The present invention relates generally to temperature sensing, and more particularly, to dual source self-calibration or auto-correction systems and methods for distributed temperature sensing.

2. Background of the Invention

Fiber optic Distributed Temperature Sensing (DTS) systems were developed in the 1980s to replace thermocouple and thermistor based temperature measurement systems. DTS technology is based on Optical Time-Domain Reflectometry (OTDR) and utilizes techniques originally derived from telecommunications cable testing. Today DTS provides a cost-effective way of obtaining hundreds, or even thousands, of highly accurate, high-resolution temperature measurements, DTS systems today find widespread acceptance in industries such as oil and gas, electrical power, and process control.

The underlying principle involved in DTS-based measurements is the detection of spontaneous Raman back-scattering. A DTS system launches a primary laser pulse that gives rise to two back-scattered spectral components. A Stokes component that has a lower frequency and higher wavelength content than the launched laser pulse, and an anti-Stokes component that has a higher frequency and lower wavelength than the launched laser pulse. The anti-Stokes signal is usually an order of magnitude weaker than the Stokes signal (at room temperature) and it is temperature sensitive, whereas the Stokes signal is almost entirely temperature independent. Thus, the ratio of these two signals can be used to determine the temperature of the optical fiber at a particular point. The time of flight between the launch of the primary laser pulse and the detection of the back-scattered signal may be used to calculate the special location of the scattering event within the fiber.

One problem involved in the operation of DTS systems is proper calibration. DTS technology derives temperature information from two back-scattered signals that are in different wavelength bands. The shorter wavelength signal is the Raman anti-Stokes signal, the longer one is usually the Raman Stokes signal. After the light from the primary source at λ₁ is launched in a temperature sensing fiber, the scattered power arising from different locations within the optical fiber contained in the Stokes (λ₁^{Stokes}) and anti-Stokes (λ₁^{Anti-Stokes}) bands travel back to the launch end and gets detected by single or multiple detectors. As the Stokes and anti-Stokes signals travel, they suffer different attenuation profiles α^{Stokes} (α_{S})) and α^{Anti-Stokes} (α_{AS}), respectively, due to the difference in the wavelength band for these two signals. For proper temperature measurement a correction needs to be made so that the two signals exhibit the same attenuation.

One approach that has been used is to assume that the attenuation profile is exponentially decaying as a function of distance. This creates an exponential function with an exponent called the Differential Attenuation Factor (DAF) that is multiplied by the Stokes signal to adjust the attenuation profile to that of the anti-Stokes signal. The ratio of the resulting two signals is then used to derive temperature. The DAF is the difference in attenuation (α_{AS}−α_{S}) between two different wavelengths.

The assumption of a smooth exponential decay however is not always a reality. A number of factors can cause the actual attenuation to deviate from the exponential form. Localized mechanical stress or strain, fiber crimping, chemical attack (eg. hydrogen ingression) all can induce abnormalities, and some of these can change with time. It has been recognized in the industry that some form of continuous calibration or auto-correction is needed to reduce all of these irregularities.

To obtain a local temperature profile along a distance, two methods—time domain approach and frequency domain approach have—been applied conventionally. The time domain method uses a pulsed light source and the position of the temperature is identified by the calculation of the pulse round trip time to the distance under test. The frequency method uses a modulated laser source and the position can be calculated by applying the inverse Fourier transformation of a sensing fiber's transfer function or frequency response.

U.S. Pat. No. 5,113,277, which is incorporated by reference, discloses a Fiber Optic DTS (Distributed Temperature Sensing) system, which involves a pulsed light source and a temperature measurement was made by the ratio between Stokes and anti-Stokes intensities at each measured distance determined from the roundtrip time of the pulse. U.S. Pat. No. 7,057,714, which is incorporated by reference, discloses a stepped modulation method to sweep the frequency of the laser source. The time domain profiles of Stokes and anti-Stokes attenuations are obtained by applying the inverse Fourier transformation of amplitude and phase responses of each modulating frequency component. The time domain method is simpler than frequency domain analysis but it requires a costly pulsed light source and higher performance data acquisition components but has lower signal to noise characteristics.

U.S. Pat. No. 7,126,680 B2, Yamate et al. proposed using two additional light sources—one in the Stokes band of the primary source and the other in the anti-Stokes band of the primary source—to generate Rayleigh OTDR signals and time-correct the attenuation profile of the back-scattered signals. Therefore, Yamate et al. effectively propose removing the attenuation component from the back-scattered Stokes and anti-Stokes signals individually. With such approaches either the availability of desired light sources or the issue of cost have been obstacles to a practical implementation.

Double ended configurations (both ends of sensing fiber connected to DTS unit to cancel out common attenuations) have been used. These may double the length of sensing fiber and the sensing time, require an extra monitoring channel, and are not universally applicable in applications where space is limited.

UK patents GB2170595, filed February 1985, and GB2210451, filed Sep. 28, 1987, teach temperature monitoring and calibration schemes. GB2170595 described two light source method by selecting the second source, whose Stokes backscattered band closely located at the anti-stokes band of the first source i.e., λ_{1AS}=λ_{2S}. GB2210451 proposed two schemes, one is using a single light source and temperature is measured by the ratio of its backscattered anti-Stokes to Stokes intensities. The second idea based on two light source is identical to GB2170595. Two source operation is based on TDM (Time Domain Multiplexing) scheme—injection of light energies of each source to the sensing fiber consecutively in pulse modes without overlap. The correction of the ambiguities in attenuation profile between Stokes and anti-Stokes were made through each source's Raleigh back scattered intensities, which is independent of temperature effect.

These teachings suffer from some important limitations. First, it is difficult to synchronize two consecutive pulses with identical condition in parameters such as modulating current amplitude, repetition rate and the pulse widths by utilizing two individual pulse modulating circuits, as these reference do. The modulating conditions of different pulse modulating circuits vary enough to cause errors in the temperature calculation. A second important issue is excessive measurement time. If two light energies at λ_{1AS} and λ_{2S} are collected for the duration of time consecutively, the total temperature measurement time will be twice the collecting time plus the processing time. Finally, the correction process in GB2170595 and GB2210451 is not effective because λ_{1AS} and λ_{2S} intensity profiles are corrected by their Rayleigh intensities, which are located at non-identical wavelength bands.

There is a need then for a much faster and more effective self-calibration or auto correction scheme.

### BRIEF SUMMARY OF THE INVENTION

The present disclosure provides economic and simple solutions to determining an accurate temperature profile in a distributed temperature optical fiber sensing system, and more particularly for correcting error generated by the ambiguities in a local sensing fiber cable's attenuation profile. In all of these schemes there is a primary light source used for temperature measurement and a correcting light source that is used only intermittently. The key to these schemes is that the primary light source is used exclusively and for the majority of the time to measure temperatures. The correcting light source is only used when needed to correct for errors in the system. The choice for when it is used is up to the operator. The scheme utilizes a secondary or correcting light source in one embodiment in which the Stokes band of the correcting light source coincides with the anti-Stokes band of the primary source of the DTS system, similar to the aforementioned prior art but its differences and advantages are describes as below. In another embodiment an advantageous scheme is to use a correcting light source in which the Stokes band of the correcting source corresponds to the primary band of the primary optical source, which means in this embodiment that the primary band of the correcting light source corresponds to the anti-Stokes band of the primary light source.

The disclosed scheme is composed of two working modes—1) a temperature measurement mode based on one source, which collects Stokes and anti-Stokes light continuously with a single primary source and 2) the correction or calibration mode, which corrects the ambiguity of the anti-Stokes backscattered intensity profile by temporarily selecting the second correction light source. The selection of the working relative split between the temperature measurement mode and the auto-correction mode can be an operator's decision, but is preferably chosen to minimize the time involved in calibration or correction mode to only the times when a correction is required. This combined operational method has the important advantage that temperature measurement time can be decreased to around half the time when compared with having two laser firings consecutively because the self-correction mode is selected only when needed.

The system may also measure the Rayleigh component at the two wavelengths. The Rayleigh back scattered light decays exponentially with distance and is temperature insensitive. Variations in the Rayleigh back scattered light amplitude may indicate fiber degradation and the rate of change of fiber degradation may indicate that a more frequent use of the self-correction mode is required. A system that periodically measures the Rayleigh signal may also be able to automatically alarm when total fiber degradation reach attenuation levels that may impact measurement accuracy and resolution.

This addresses the limitation mentioned previously about the prior art that if two light energies at λ_{1AS} and λ_{2S} are collected consecutively for the duration of time, the total temperature measurement time will be as much as twice the collecting time plus the processing time. In the proposed scheme though this does not happen. The primary light source is being used the majority of the time.

In addition to this time saving feature the two lasers light sources are operated by a single pulse modulating circuit. This aspect provides common modulating parameters for two lasers continuously. It is difficult to synchronize two consecutive pulses with identical condition in parameters such as modulating current amplitude, repetition rate and the pulse widths by utilizing two individual pulse modulating circuits. The present invention has a single pulse modulating circuit that drives both the measurement mode and correction mode—that is, the primary light source and the secondary light source.

The selection of the self-calibration or auto correction mode is made by use of a commercially available optical switch. This proposed scheme provides stable and accurate calibration. In addition, the calibration is more effective because the two wavelengths are located in the same wavelength i.e., λ_{1AS}˜λ_{2S}.

In one embodiment, a method of auto-corrected temperature measurement in a system using a fiber optic distributed sensor includes at least of the steps of: continuously providing a primary light source light pulse energy into a sensing fiber by the selection of an optical switch; collecting backscattered Raman Stokes and anti-Stokes light components; calculating temperatures using the intensities of the backscattered Raman Stokes and anti-Stokes light components; and then only intermittently switching to a correction mode including at least the steps of selecting with an optical switch a correcting light source and providing it to the sensing fiber; collecting a backscattered Raman Stokes component of that correcting light source; using that Raman Stokes component collected from the correcting light source to correct the Raman anti-Stokes profile collected from the primary light source; and then calculating the corrected temperature from the corrected anti-Stokes profile. In this scheme both the primary light source and correcting light source are pulsed continuously by a common pulse-modulating device.

In one version of the above scheme the correcting light source is chosen so that the Stokes band of the correcting light source coincides with the anti-Stokes band of the primary source. In another possible version an advantageous scheme is to use a correcting light source in which the Stokes band of the correcting source corresponds to the primary band of the primary optical source, which means in this embodiment that the primary band of the correcting light source corresponds to the anti-Stokes band of the primary light source.

The schemes of the present disclosure can be implemented using either or both a time domain method which uses optical pulsed light sources (for the first and second light sources) or a frequency domain method, which is based on other types of modulation known in the art of the first and second light sources. An example of frequency domain methodology is found in U.S. Pat. No. 7,057,714, which is incorporated by reference.

### BRIEF DESCRIPTION OF THE SEVERAL VIEWS OF THE DRAWINGS

For a more complete understanding of the present invention, reference is now made to the following drawings, in which,

FIG. 1 shows a block diagram of a prior art DTS system.

FIG. 2 shows a block diagram of a DTS system configured for a dual light calibration.

FIG. 3 illustrates an aspect of choice of primary and secondary light sources.

FIG. 4 illustrates a back-scattered light signal from a conventional DTS trace.

FIG. 5 illustrates a back-scattered signal from a dual light arrangement.

FIG. 6 illustrates the OTDR signal from four different sensing fiber probes.

FIG. 7 illustrates the temperature measurements of the four sensing fiber probes without attention correction in a single light system.

FIG. 8 illustrates temperature measurements using the dual light proposal of the present invention without attenuation adjustments.

FIG. 9 illustrates an aspect of choice of primary and secondary light sources.

### DETAILED DESCRIPTION OF THE INVENTION

In the following detailed description, reference is made to accompanying drawings that illustrate embodiments of the present invention. These embodiments are described in sufficient detail to enable a person of ordinary skill in the art to practice the invention without undue experimentation. It should be understood, however, that the embodiments and examples described herein are given by way of illustration only, and not by way of limitation. Various substitutions, modifications, additions, and rearrangements may be made without departing from the spirit of the present invention. Therefore, the description that follows is not to be taken in a limited sense, and the scope of the present invention will be defined only by the final claims.

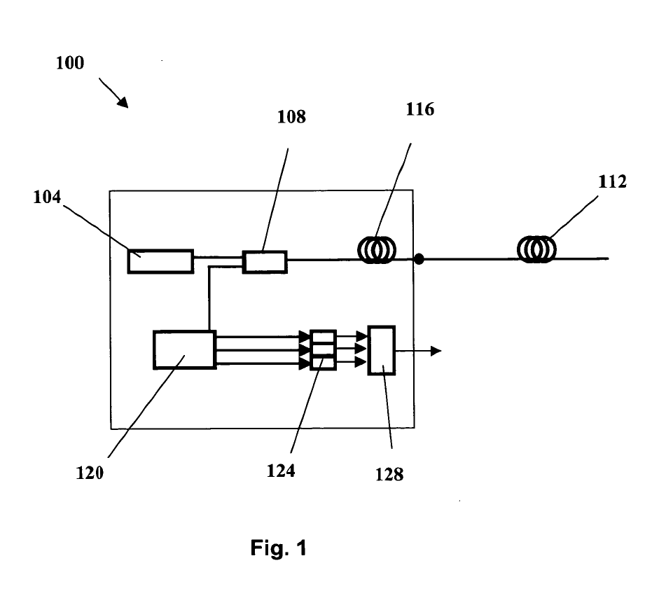

Turning now to FIG. 1, a prior art single source DTS system, shown generally by the numeral 100 is depicted. In operation, a pulsed laser light having a wavelength λ₁ is generated by primary laser source 104 and it is fed to sensing optical fiber 112 through optical combiner/splitter 108. An internal reference fiber coil 116 is located within the DTS and is maintained at a known temperature θ. Light is back-scattered as the pulse propagates through fiber 112, owing to changes in density and composition as well as to molecular and bulk vibrations. In a homogeneous fiber, the intensity of the back-scattered light decays exponentially with time.

Because the velocity of light propagation in optical fiber 112 is well known, the distance may be determined from the time-of-flight of the returning back-scattered light. The back-scattered light reaches optical combiner/splitter 108 and comprises different spectral components due to different interaction mechanisms between the propagating light pulse and the optical fiber. Back-scattered spectral components include Rayleigh, Brillouin, and Raman peaks or bands. Optical combiner/splitter 108 directs these mixed spectral components to optical filter 120, which separates the back-scattered components into the bands of interest, which may be the Rayleigh, Raman Stokes and Raman anti-Stokes wavelengths and then feeds them into necessary photo-detectors 124. Three photo detectors are shown for illustrative purposes. The signals from photo-detectors are fed to a programmed signal processor that outputs temperature as a function of location along sensing fiber 112.

The Rayleigh backscattering component (λ_{R}) is the strongest signal and has the same wavelength as primary laser pulse λ₁. As such, the Rayleigh component controls the main slope of the intensity decay curve and may be used to identify the breaks and heterogeneities along the fiber. The Rayleigh component is not sensitive to temperature, i.e., is temperature independent.

The Brillouin backscattering components are caused by lattice vibrations from the propagating light pulse. However, these peaks are spectrally so close to the primary laser pulse that it is difficult to separate the Brillouin components from the Rayleigh signal.

The Raman backscattering components are caused by thermally influenced molecular vibrations from the propagating light pulse. Thus, their intensities depend on temperature. The Raman back-scattered light has two components that lie symmetric to the Rayleigh peak: the Stokes peak (λ_{S}) and the anti-Stokes peak (λ_{AS}).

The intensity (I_{AS}) of the anti-Stokes peak is typically lower than the intensity (I_{S}) of the Stokes peak, but is strongly related to temperature, whereas the intensity of the Stokes peak is only weakly related to temperature. By calculating a ratio of the anti-Stokes to Stokes signal intensities, an accurate temperature measurement can be obtained. Combining this temperature measurement technique with distance measurement through time-of-flight of light, the DTS system may provide temperature measurements incrementally along the entire length of optical fiber 112.

In a typical single light source Raman DTS system, the temperature is measured by the intensity ratio R(T) between anti-Stokes (I_{AS}) and Stokes (I_{S}) signals, the temperature information can be obtained according to Equation 1:

$$R ( T ) = \frac{{I}_{AS}}{{I}_{S}} = {( \frac{{λ}_{S}}{{λ}_{AS}} )}^{4} \cdot exp ( - \frac{hcv}{kT} ) \qquad Eq . ( 1 )$$

where λ_{S} and λ_{AS} are the Stokes and anti-Stokes wavelengths, v is their wave number separation from the input wavelength λ₁, h is Planck's constant, c is the velocity of the light, k is Boltzmann's constant, and T is the absolute temperature of the fiber core under measurement.

The input signal travels along the fiber to the measurement location and the scattered signals travel back to a detector, which adds to the back-scattered signals the attenuation effect in both directions. Further, there is a slight difference in attenuation factor between anti-Stokes signal and Stokes signal due to the difference in wavelength while traveling back from the measurement point to the detector. Aside from the non-linear effects, optical fibers generally exhibit higher attenuation for shorter wavelength, and therefore, anti-Stokes signals usually have higher attenuation than Stokes signals. As a result, with the assumption that the optical signals attenuate exponentially along fiber 103, Equation 1 may be modified to take the effect of fiber-induced attenuation as follows:

$$R ( T ) = \frac{{I}_{AS}}{{I}_{S}} = {( \frac{{λ}_{S}}{{λ}_{AS}} )}^{4} \cdot exp ( - \frac{hcv}{kT} ) \cdot exp [ l \cdot ( {α}_{AS} - {α}_{S} ) ] \qquad Eq . ( 2 )$$

where I is the length of the fiber that the signals have traveled, and α_{AS} and α_{S} are the attenuation factors in anti-Stokes and Stokes wavelength, respectively.

Before using the equations to derive the temperature, the differential attenuation induced component may be removed. The typical method is to move the (α_{AS}−α_{S}) factor (referred to as differential attenuation factor or DAF) to the left side of Equation 2. The DAF may be predetermined for a given fiber type, and the temperature then may be derived by multiplying the Stokes data by a DAF-induced exponential factor:

$$\frac{AS}{S \cdot exp ( l \cdot DAF )} = {( \frac{{λ}_{S}}{{λ}_{AS}} )}^{4} \cdot exp ( - \frac{hcv}{kT} ) \qquad Eq . ( 3 )$$

This operation is based on the assumption that the attenuation profiles of all optical signals traveling along the fiber are exponentially decaying as a function of the distance. Although this is generally true with most optical fibers in good physical condition, physical stress/strain, extremely high/low temperature, and/or hydrogen ingression may cause the attenuation profile of the back-scattered signals to deviate from the originally measured and calibrated form. In such cases, a single static DAF based correction factor may no longer be sufficiently accurate or effective.

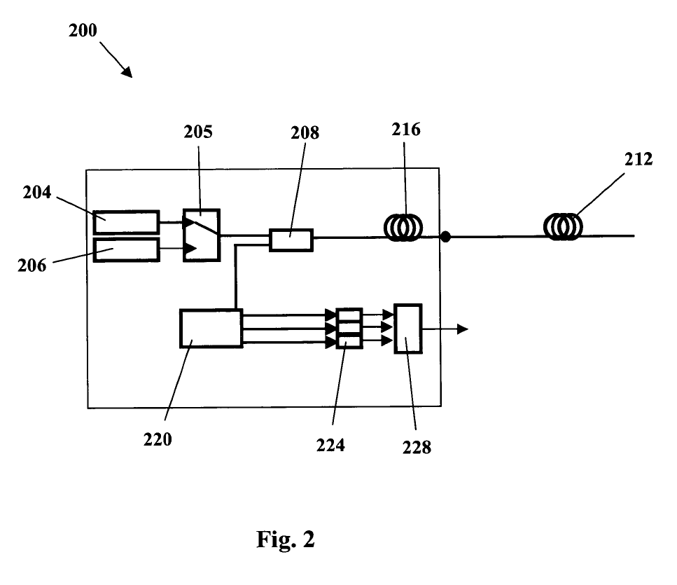

FIG. 2, shown generally as the numeral 200 shows a block diagram of an alternate DTS system capable of performing a self-calibration or auto correction method according to an embodiment of the present invention. Primary light source 204 (wavelength λ₁) and secondary light source 206 (wavelength λ₂) may alternatively feed primary and secondary optical signals into sensing fiber 212 and reference fiber coil 216 via optical switch 205. Both the primary and secondary light sources are driven by one common When optical switch 205 is in a first position, primary source 204 produces primary back-scattered signals from sensing fiber 212. When optical switch 205 is in a second position, secondary source 206 produces secondary back-scattered signals from sensing fiber 212. Optical combiner/splitter 208 directs these mixed spectral components to optical filter 220, which separates the back-scattered components into the bands of interest, which may be the Rayleigh, Raman Stokes and Raman anti-Stokes frequencies of the primary or secondary light sources and then feeds them into photo-detectors 124. Three photo detectors are shown for illustrative purposes, but more are possible. The signals from photo-detectors are fed to a programmed signal processor that outputs temperature as a function of location along sensing fiber 212.

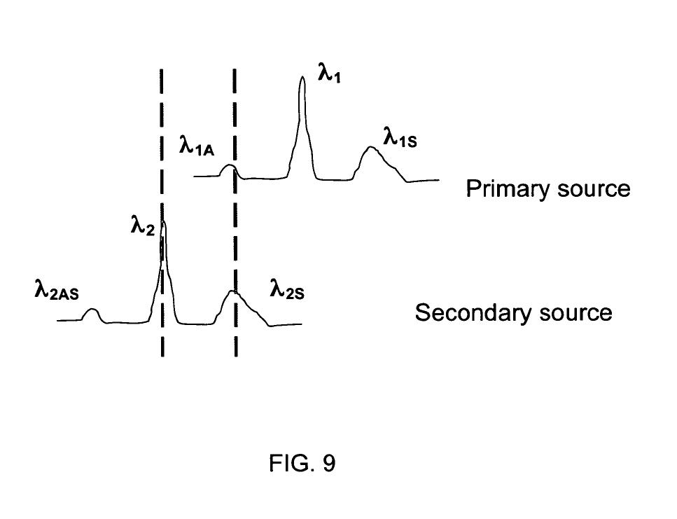

One embodiment is to choose the secondary or correction light source so that the backscattered Stokes band is a close match to the backscattered anti-Stokes band of the primary or measurement light source. This is illustrated in FIG. 9. The secondary light source's Stokes attenuation profile, without or with the minimum temperature effect, may be used to correct the anti-Stokes profile made by the primary light source during a measurement mode. Thus, the generation of an extra wavelength band via a second light source that may be insensitive to temperature effects and corresponds to an anti-Stokes band of the DTS unit (e.g., primary light source) may be used to correct temperature error induced by anti-Stokes profile in the first primary light source. Thus two like bands, one from the anti-Stokes of a primary light source (in measurement mode) and the other from the Stokes band of the secondary light source (in correction mode) may pass through a wavelength selector and then detected with an optical detector.

A proven example of this embodiment is a commercially available measurement light source of primary wavelength of 1064 (nm). This has an anti-Stokes band of wavelength 1018.7 (nm) and a Stokes band of wavelength 1109.3 (nm). Then a correcting light source is a commercially available one with a primary wavelength of 980 (nm) and an anti-Stokes of 941.6 (nm) with a Stokes of 1018.4 (nm). The anti-Stokes band (1018.7) of the measurement source is almost identical to the Stokes band (1018.4) of the correction source.

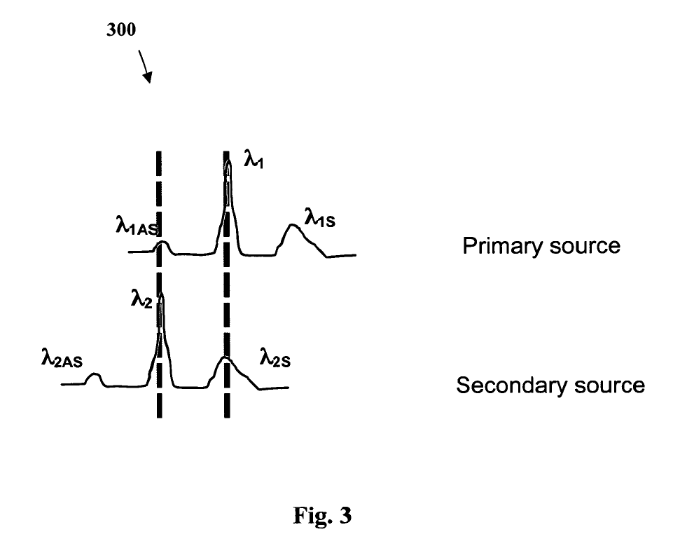

In a second embodiment, the wavelength of the secondary source (λ₂) is chosen to coincide with the anti-Stokes wavelength (λ₂_{_{—}}_{AS}) of the primary source. This is shown in FIG. 3, shown generally by the numeral 300. If secondary source wavelength is chosen to match the anti-Stokes of the primary wavelength then the Stokes wavelength of the secondary is a close match to the primary wavelength λ₁. As discussed in more detail below in the following derivations, this configuration eliminates the need to use any Rayleigh signal for adjustments, and accurate temperature may be measured using only the Stokes and anti-Stokes signals.

A proven example of this second embodiment is a commercially available measurement light source of primary wavelength of 975 (nm) coupled with a correcting light source of 940 (nm).

In some embodiments, the primary light source and the secondary light source may be the same light source, i.e., a dual wavelength laser source operable to provide at least two optical signals to the sensing fiber. In this case an optical switch may not be needed. The dual wavelength laser source may operate at a first wavelength and at least the anti-Stokes band may be collected. Next, the dual wavelength laser source may operate at a second wavelength and at least the Stokes band may be collected, where the anti-Stokes and Stokes band are substantially similar.

The attenuation factor varies as a function of wavelength and between anti-Stokes and Stokes signals because those signals are not in the same wavelength. Furthermore, localized variation in attenuation need not be assumed to be in exponential form, and attenuation along fiber 212 may be expressed as a general function that has variables of wavelength and location, as f(λ,I). Thus, Equation 2 may be modified as follows:

$$R ( T ) = \frac{{I}_{AS}}{{I}_{S}} = {( \frac{{λ}_{S}}{{λ}_{AS}} )}^{4} \cdot exp ( - \frac{hcv}{kT} ) \cdot \frac{f ( {λ}_{AS} , l )}{f ( {λ}_{S} , l )} \qquad Eq . ( 4 )$$

This holds true as long as the Stokes and anti-Stokes signals are from the same input light source. With two input sources, we may designate their wavelengths as λ₁ for the primary source and λ₂ for the secondary source. Furthermore, by setting the wavelength of the secondary source to approximately coincide with the anti-Stokes wavelength of the primary source such that λ₂=λ₁_{_{—}}_{AS}, then the Stokes wavelength of the secondary source may approximately coincide with the input wavelength of the primary source, λ₂_{_{—}}_{S}=λ₁.

The use of the Stokes signal back-scattered from the secondary source in place of the Stokes signal back-scattered from the primary source allows Equation 4 to be modified as follows:

$$R ( T ) = \frac{{I}_{1 \_ AS}}{{I}_{2 \_ S}} = \frac{{I}_{1}}{{I}_{2}} \cdot {( \frac{{λ}_{2 \_ s}}{{λ}_{1 \_ as}} )}^{4} \cdot exp ( - \frac{hcv}{kT} ) \cdot \frac{f ( {λ}_{1} , l ) \cdot f ( {λ}_{1 \_ AS} \cdot l )}{f ( {λ}_{S} , l ) \cdot f ( {λ}_{2 \_ S} , l )} \\ R ( T ) = \frac{{I}_{1 \_ AS}}{{I}_{2 \_ S}} = \frac{{I}_{1}}{{I}_{2}} \cdot {( \frac{{λ}_{1}}{{λ}_{2}} )}^{4} \cdot exp ( - \frac{hcv}{kT} ) \cdot \frac{f ( {λ}_{1} , l ) \cdot f ( {λ}_{2} \cdot l )}{f ( {λ}_{2} , l ) \cdot f ( {λ}_{1} , l )} \\ R ( T ) = \frac{{I}_{1}}{{I}_{2}} \cdot {( \frac{{λ}_{1}}{{λ}_{2}} )}^{4} \cdot exp ( - \frac{hcv}{kT} ) \qquad Eq . ( 5 )$$

This algebraic manipulation demonstrates that with the inventive choice of primary and secondary light sources temperature information can now be derived without having to handle differential attenuation.

In another embodiment that takes advantage of the inventive choice of primary and secondary light sources, the difference in attenuation between the Stokes signal of the primary source and the Stokes signal of the secondary source may be used as a correction factor, which may be expressed as

$$\frac{{I}_{1 \_ AS}}{{I}_{2 \_ S}} = \frac{{I}_{1 \_ AS}}{{I}_{1 \_ S}} \cdot \frac{{I}_{1 \_ S}}{{I}_{2 \_ S}} \qquad Eq . ( 6 )$$

In this manner, both the primary and secondary light sources may be used to generate a correction factor (I_{1-S}/I_{2-S}) and then a single source may be used for temperature measurement with the correction factor applied to the anti-Stokes/Stokes ratio from that source. The user can thus periodically or on demand generate a new set of correction factors using the primary and secondary sources.

The advantages of the present invention include the elegance of its configuration and ease of use. The embodiments of the present invention utilize a single additional source as the secondary source for auto correction, as opposed to two additional sources. They use Raman scattering, not Rayleigh scattering, for performing wavelength adjustments, and require only a ratio between Stokes and anti-Stokes signals without consideration for differential attenuation to generate temperature information. Moreover, the simpler processing described herein results in more accurate and reliable temperature measurements.

To calculate the absolute temperature, the reference fiber-coil located in DTS unit (116 in FIG. 1 or 216 in FIG. 2) is maintained at a known temperature θ. Then unknown temperature T along the arbitrary section of the sensing fiber can be calculated by rearranging the above equation as,

$$T = {[ \frac{1}{θ} - \frac{k}{hcv} ln ( \frac{R ( T )}{R ( θ )} ) ]}^{- 1} \qquad Eq . 7$$

where R(T) and R(θ) are the back scattering ratios measured at the arbitrary section of the sensing fiber and at the reference fiber-coil respectively. The intensity terms I₁, I₂ in Equation 5 are integrated into R(T) and R(θ) in Equation 7.

### Experimental Verification

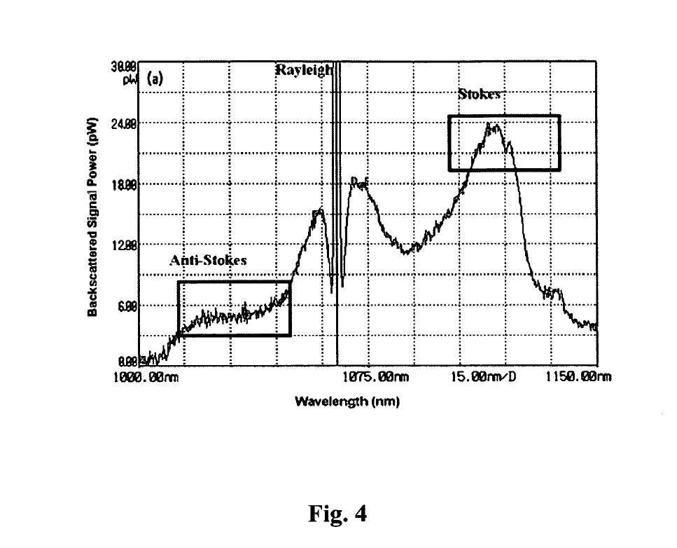

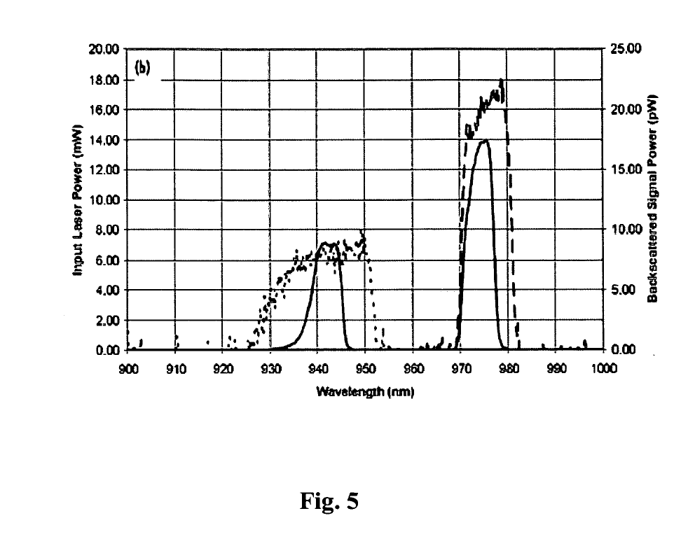

In an experimental set-up similar to FIG. 2 two laser sources 975 nm (primary) and 940 nm (secondary) were operated in pulse mode and selected alternatively using an optical switch, and the scattered signals collected in sequence by Si APD (Avalanche Photo-Diodes). The anti-Stokes signal is collected with 975 nm laser connection selected, while the Stokes signal is collected with the 940 nm laser selected. A back-scattered spectrum of the single source system is shown in FIG. 4 and the proposed dual-source system back-scattered Raman intensities are plotted in FIG. 5. Two solid lines located at 940 nm and 975 nm indicate the Rayleigh bands of the secondary and the primary light sources. And two dotted lines containing the solid lines indicate the anti-Stokes and Stokes bands of the primary and secondary light sources respectively.

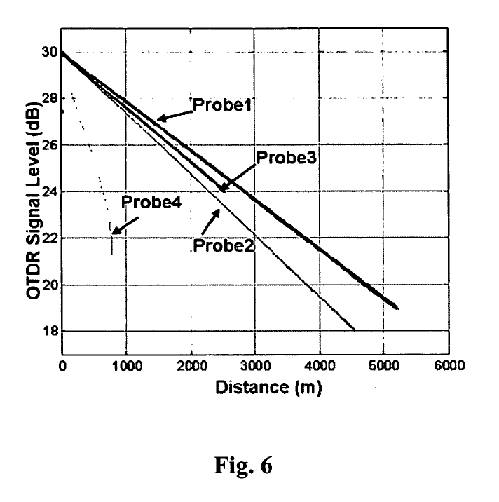

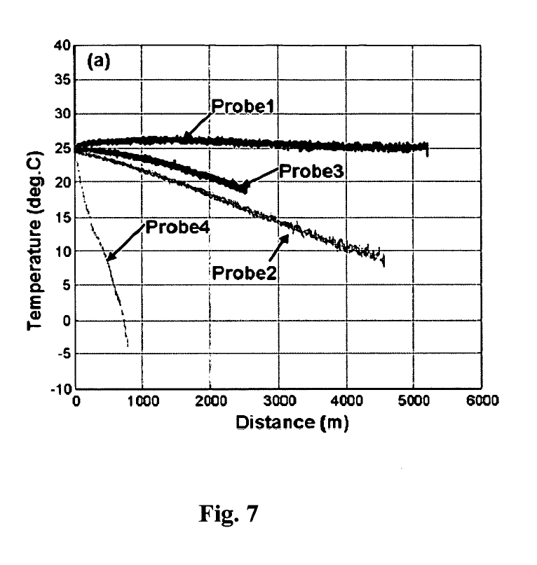

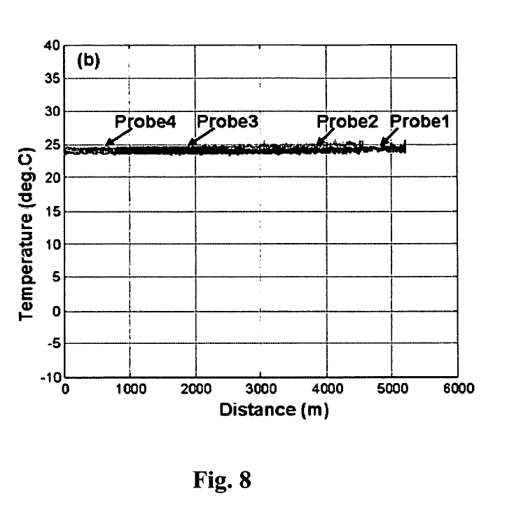

Four different multimode fibers were used for test probes—three fibers in normal condition from different manufacturers, and one fiber that is hydrogen-darkened in an oil well (all in 50/125/250 GI MM fibers: OFS 5 km, Spectran 4.5 km, Corning 2 km and hydrogen darkened 800 m). All the fiber spools were kept under room temperature and a 30 second OTDR trace and a 2-minute temperature trace are taken with each fiber operated by regular DTS and the self-correction mode consecutively. FIG. 6 shows the comparison in OTDR traces produced by the fibers in the single source mode, which clearly show different attenuations from fiber to fiber, and it also shows locally generated non-linear attenuation in the darkened fiber (Probe 4). Then all probe fibers are connected consecutively and the temperature traces are derived without taking any actions to correct the differential attenuations. The resulting temperature profiles produced by normal single mode operation are plotted in FIG. 7. Calculation errors are evident among different fibers due to differential attenuation. However FIG. 8 shows the temperature traces measured by the dual-light auto-correction mode. These display correct temperature profiles for all fibers, independent of their inherent attenuation profiles. The dual light mode is easily programmed to be an automated system.

Although certain embodiments of the present invention and their advantages have been described herein in detail, it should be understood that various changes, substitutions and alterations can be made without departing from the spirit and scope of the invention as defined by the appended claims. Moreover, the scope of the present invention is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods or steps.

1. A method of auto-correcting temperature measurement in a system using a fiber optic distributed sensor comprising the steps of:
a. in a measurement mode providing a primary light source light pulse energy into a sensing fiber by selection using an optical switch;
i. collecting backscattered Raman Stokes and anti-Stokes light components;
ii. calculating temperatures using the intensities of the backscattered Raman Stokes and anti-Stokes light components;
b. during a correction mode selecting with the optical switch a secondary light source and providing pulses of said secondary light source to the sensing fiber;
i. collecting a backscattered Raman Stokes component of that secondary light source;
ii. using that Raman Stokes component collected from the secondary light source in said correction mode to correct a Raman anti-Stokes profile collected from the primary light source while in measurement mode;
iii. calculating a corrected temperature from the corrected anti-Stokes profile.
c. wherein the primary light source and secondary light source are pulsed by a common pulse modulating device; and
d. wherein the primary light source and secondary light source are chosen so that a backscattered anti-Stokes band of said primary light source is substantially the same as a backscattered Stokes band of said secondary light source.

2. The method of auto-correcting temperature measurement in a system using a fiber optic distributed sensor of claim 1 wherein said primary light source and said secondary light source are provided by a multiple wavelength laser source configured to provide at least two optical signals.

3. The method of auto-correcting temperature measurement in a system using a fiber optic distributed sensor of claim 2 wherein said multiple wavelength laser source is configured to deliver two different wavelengths chosen so that the backscattered anti-Stokes band of the first is substantially the same as the backscattered Stokes band of the second.

4. A system for auto-correcting temperature measurement in a system using a fiber optic distributed sensor comprising:
a. a distributed fiber optic sensor;
b. a primary light source for providing a back-scattered anti-Stokes band from said distributed fiber optic sensor;
c. a secondary light source with a wavelength chosen to coincide with said back-scattered anti-Stokes band provided by said primary light source, said secondary light source providing a back-scattered Stokes band from said distributed fiber optic sensor;
d. an optical switch for selecting between said primary and secondary light sources; and
e. a common pulse-modulating device for providing pulses to said primary light source and said secondary light source;
f. wherein the system for auto-correcting temperature measurement calibrates and measures the temperature distribution along said distributed fiber optic sensor based on the ratio of the anti-Stokes band of the primary light source and the Stokes band of the secondary light source.

5. The system for auto-correcting temperature measurement in a system using a fiber optic distributed sensor of claim 4 wherein said primary light source and said secondary light source are provided by a multiple wavelength laser source configured to provide at least two optical signals.

6. A method of auto-correcting temperature measurement in a system using a fiber optic distributed sensor comprising the steps of:
a. injecting a primary light source light pulse energy into a sensing fiber by selection using an optical switch;
b. collecting back-scattered light energy at the Raman anti-Stokes wavelength of the primary light energy and measuring its intensity;
c. injecting secondary light energy into the fiber at the Raman anti-Stokes wavelength of the primary light energy using a secondary light source;
d. collecting back-scattered light energy at the Raman Stokes wavelength of the secondary light energy and measuring its intensity; and
e. calculating a temperature using the back-scattered anti-Stokes signal of the primary light energy and the back-scattered Stokes signal of the secondary light energy;
f. wherein the primary light source and correcting light source are pulsed by a common pulse modulating device.

7. The method of auto-correcting temperature measurement in a system using a fiber optic distributed sensor of claim 6 wherein said primary light source has a wavelength of about 975 nanometers and said secondary light source has a wavelength of about 940 nanometers.

8. The method of auto-correcting temperature measurement in a system using a fiber optic distributed sensor of claim 6 wherein said calculating step is performed without measuring or using differential attention profiles.

9. A system for auto-correcting temperature measurement in a system using a fiber optic distributed sensor comprising:
a. a distributed fiber optic sensor;
b. a primary light source for providing a back-scattered anti-Stokes band from said distributed fiber optic sensor;
c. a secondary light source with a wavelength chosen to coincide with said back-scattered anti-Stokes band provided by said primary light source, said secondary light source providing a back-scattered Stokes band from said distributed fiber optic sensor;
d. an optical switch for selecting between said primary and secondary light sources; and
e. a common pulse-modulating device for providing pulses to said primary light source and said secondary light source;
f. wherein the system for auto-correcting temperature measurement calibrates and measures the temperature distribution along said distributed fiber optic sensor based on the ratio of the anti-Stokes band of the primary light source and the Stokes band of the secondary light source.

10. A method of auto-correcting temperature measurement in a system using a fiber optic distributed sensor comprising the steps of:
a. injecting primary light energy into a sensor fiber using a primary light source;
b. collecting back-scattered light energy at the Raman Stokes wavelength of the primary light source and measuring its intensity;
c. injecting secondary light energy into the fiber at the Raman anti-Stokes wavelength of the primary light source using a secondary light source;
d. collecting back-scattered light energy at the Raman Stokes wavelength of the secondary light source and measuring its intensity;
e. calculating a ratio between the back-scattered Stokes signal of the primary light source and the back-scattered Stokes signal of the secondary light source to produce an Attenuation Correction Factor at one or more positions along the sensor fiber; and
f. adjusting a temperature measured by the fiber optic distributed temperature sensor using the Attenuation Correction Factor.
g. wherein the primary light source and correcting light source are pulsed by a common pulse modulating device.

11. The method of auto-correcting temperature measurement in a system using a fiber optic distributed sensor of claim 10 wherein said temperature measured by the fiber optic distributed temperature sensor is measured by
a. injecting primary light energy into said sensor fiber using a primary light source;
b. collecting back-scattered light energy at the Raman anti-Stokes wavelength of the primary light source and measuring its intensity;
c. collecting back-scattered light energy at the Raman Stokes wavelength of the primary light source and measuring its intensity; and
d. calculating a ratio between the intensities of the back-scattered Raman anti-Stoke and Stokes wavelengths.
